(19) United States
(12) Patent Application Publication
(10) Pub. No.: US 2024/0371154 A1
(43) Pub. Date: Nov. 7, 2024

(54) MACHINE LEARNING BASED APPROACH FOR QUANTIFICATION OF METHANE EMISSIONS USING SATELLITE DATA FROM HYDROCARBON RECOVERY

(71) Applicant: Landmark Graphics Corporation, Houston, TX (US)

(72) Inventors: Bilal Hungund, Bangalore (IN); Gurunath Gandikota, Bangalore (IN); Geetha Nair, Houston, TX (US)

(21) Appl. No.: 18/312,084

(22) Filed: May 4, 2023

(51) Int. Cl. G06V 20/13; G06Q 50/26

(52) U.S. Cl. CPC G06V 20/13; G06Q 50/26

(57) ABSTRACT

A method for determining an emissions associated with hydrocarbon recovery of a hydrocarbon site within a geographic region, the method comprises selecting the hydrocarbon site for which to determine the emissions. The method comprises determining current values of hydrocarbon related attributes that affect emissions at the hydrocarbon site for a current time frame. The method comprises inputting the current values of the hydrocarbon related attributes related to emissions at the hydrocarbon site into a learning machine to generate an emissions factor for each of the hydrocarbon related attributes that affect the emissions at the hydrocarbon site.

### TECHNICAL FIELD

This disclosure relates generally to the field of hydrocarbon site emissions and more particularly to the field of quantifying emissions associated with hydrocarbon recovery of a hydrocarbon site based on satellite and ground inventory data.

### BACKGROUND

Emissions from hydrocarbon sites associated with exploration, production, transportation, etc. of hydrocarbons may be measured and/or reduced to address the impact of greenhouses gases that may have on the Earth's atmosphere. For example, methane is a potent greenhouse gas that is emitted from hydrocarbon sites and may affect the Earth's atmosphere. Emissions from hydrocarbon sites may be measured at the ground level. This may require expensive drone equipment and provide intermittent data (e.g., a data point every 3 months, every 6 months, etc.). This intermittent data may result in missing stochastic characteristics of high emitting sites and subsequently may add error into emissions estimations of a hydrocarbon site. Additionally, ground level measurements may also restrict the spatial resolution. For example, ground level measurements may only provide emissions for a portion of a basin (e.g., 400 kilometers (km) by 480 km) with multiple hydrocarbon sites. Another approach to measuring emissions from hydrocarbon sites includes utilizing data from satellite observations. Satellite data may provide continuous monitoring, thus reducing error in emissions measurements. Additionally, atmospheric inverse modeling and the ground inventory may be utilized to link the satellite data to greenhouse gas emissions at the ground level.

### BRIEF DESCRIPTION OF THE DRAWINGS

Embodiments of the disclosure may be better understood by referencing the accompanying drawings.

FIG. 1 is a conceptual diagram depicting example regions with hydrocarbon sites, according to some embodiments.

FIG. 2 is a flowchart depicting example operations for determining emissions for hydrocarbon recovery of a hydrocarbon site, according to some embodiments.

FIG. 3 is a flowchart depicting example operations to configure a learning machine, according to some embodiments.

FIG. 4 is a flowchart depicting example operations to train a learning machine, according to some embodiments.

FIGS. 5A-5B are illustrations depicting example domains of interest, according to some embodiments.

FIGS. 6A-6B are illustrations depicting example satellite data, according to some embodiments.

FIG. 7 is a block diagram depicting an example computer, according to some embodiments.

### DESCRIPTION

The description that follows includes example systems, methods, techniques, and program flows that embody aspects of the disclosure. However, it is understood that this disclosure may be practiced without these specific details. For instance, this disclosure refers to satellite data obtained from a TROPOspheric Monitoring Instrument (TROPOMI) satellite. Aspects of this disclosure can also be applied to satellite data from any other satellite with different resolutions, global coverage frequency, etc. For clarity, some well-known instruction instances, protocols, structures, and operations have been omitted.

Emissions associated with the recovery of hydrocarbons (i.e., oil and gas) from hydrocarbon sites may be quantified by measuring emissions via satellite data. Satellite data may provide continuous monitoring of greenhouse gas emissions, such as methane emissions, carbon dioxide emissions, etc. Atmospheric inversion modeling may be utilized to link emissions rates from hydrocarbon related attributes that affect hydrocarbon sites and satellite data of emissions over a region. However, determining emissions rates via inversion may be time consuming and computationally complex.

Emissions factors may also be obtained from public sources, such as emissions factors published by the Environmental Protection Agency (EPA) and may be utilized to determine emissions of hydrocarbon sites. However, these published emission factors may underestimate emissions from various ground sources. Some embodiments may utilize a learning machine trained to quantify emissions of hydrocarbon sites based on satellite data, as described herein.

In some embodiments, a geographic area on the Earth's surface may be selected. Some embodiments may obtain satellite data for each of the geographic regions. For example, satellite data of emissions columnar concentrations for a geographic region at a current time frame may be obtained. Additionally, some embodiments may also obtain emissions samples for each of the geographic regions at the current time frame. For example, emissions samples may include a level of emissions caused by the recovery of hydrocarbons (e.g., emissions factors published by the EPA, emissions factors obtained from the Oil Production Greenhouse Gas Emissions Estimator (OPGEE), etc.). In some embodiments, posterior emissions estimations for each of the geographic regions may be generated, via atmospheric inverse modeling, based on the satellite data and the emissions samples for each geographic region at the current time frame. Some embodiments may obtain hydrocarbon related attributes of hydrocarbon sites located in each of the geographic regions. For example, inventory data, operational data, metadata, etc. for each hydrocarbon site in a geographic region may be obtained. In some embodiments, the hydrocarbon related attributes of each geographic region and the posterior emissions estimations for the corresponding geographic region may be utilized to train a learning machine to generate emissions factors for hydrocarbon related attributes.

In some embodiments, the emissions factors for hydrocarbon related attributes may be determined by the learning machine. For instance, to quantify the emissions of a hydrocarbon site, the hydrocarbon related attributes of the hydrocarbon site may be determined. The hydrocarbon related attributes may then be input into the learning machine to generate emissions factors for each of the hydrocarbon related attributes that affect emissions at the hydrocarbon site. Some embodiments may then generate the emissions associated with hydrocarbon recovery of the hydrocarbon site based on the emissions factors of the hydrocarbon related attributes of the hydrocarbon site. Some embodiments may update the learning machine when new satellite data is obtained, and subsequently update emissions factors for each hydrocarbon related attribute. For example, new satellite data may be obtained at a time frame after the time frame of the corresponding training data (i.e., posterior emissions and hydrocarbon related attributes of a geographic region) in which the learning machine was initially trained with. The learning machine may then be trained (i.e., updated) with the new satellite data (i.e., update posterior estimated emissions via atmospheric inversion modeling).

In some embodiments, a hydrocarbon site operation may be performed based on the emission factors of the attributes and/or site. For example, hydrocarbon site operations may be initiated, modified, or stopped based on the emissions factors of an attribute, plurality of attributes, site, etc. to limit emissions. Examples of hydrocarbon site operations may include shutting in a well, repairing equipment, adjusting a choke manifold, adjusting and/or stopping drilling operations, etc. For instance, the emissions from multiple time frames may indicate a leaking valve on a flow line. Accordingly, in this example situation, the valve may be repaired, the well may be shut in, or fluid flow may be diverted from the leaking valve to reduce emissions.

### Example System

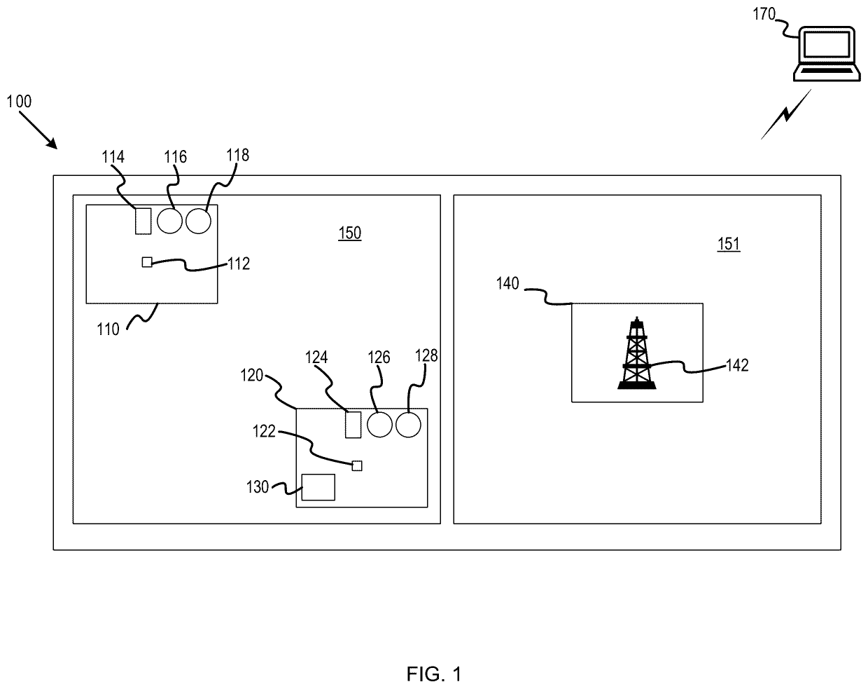

FIG. 1 is a conceptual diagram depicting example regions with hydrocarbon sites, according to some embodiments. FIG. 1 includes a geographic area 100. In some embodiments, the geographic area 100 may be a basin in an offshore or onshore environment. The geographic area 100 includes geographic regions 150 and 151. Each of the geographic regions 150, 151 may include hydrocarbon sites such as the hydrocarbon sites 110, 120, and 140, respectively. The hydrocarbon sites 110, 120, 140 within geographic regions 150 and 151 of may include sites associated with the exploration, completion, production, transportation, refining, etc. operations for oil and gas extracted from the Earth. Hydrocarbon sites 110 and 120 depict example well sites within the region 150 where hydrocarbons may be produced and stored. Hydrocarbon site 140 depicts an example drilling site where a new wellbore may be drilled in the Earth.

Each of the hydrocarbon sites 110, 120, and 140 may include hydrocarbon related attributes. The hydrocarbon related attributes may include inventory data, operational data, metadata, site data, etc. The inventory may include one or more wellheads, tanks, compressors, separators, pumps, heaters, etc. For example, hydrocarbon site 110 includes a wellhead 112, a heater 114, and tanks 116, 118. Hydrocarbon site 120 includes a wellhead 122, a heater, 124, tanks 126, 128, and a compressor 130. Hydrocarbon site 140 includes a drilling rig 142 that may include equipment associated with drilling operations such as mud pumps, pits, flares, etc. The operational data may include one or more pressures, flow rates, measurements, well parameters, production parameters, etc. For example, hydrocarbon sites 110, 120 and 140 may include an oil flow rate, a gas flow rate, a wellhead pressure, etc. The metadata may include size, rating, default units, material, physical properties, etc. For example, the metadata may be for each piece of equipment (i.e., inventory data) on a hydrocarbon site. The site data may include the name of the hydrocarbon site, size of the hydrocarbon site, etc.

Each of the hydrocarbon related attributes associated with the hydrocarbon sites 110, 120, and 140 may emit greenhouse gases (e.g., methane). The emission factor for each of the attributes may be utilized to quantify the emissions from each hydrocarbon related attribute and/or the site. Satellite data (i.e., methane emissions concentrations over the geographic area 100) may be utilized, by a learning machine, to determine the emissions factors of each attribute and/or hydrocarbon site within a region of interest, as described herein.

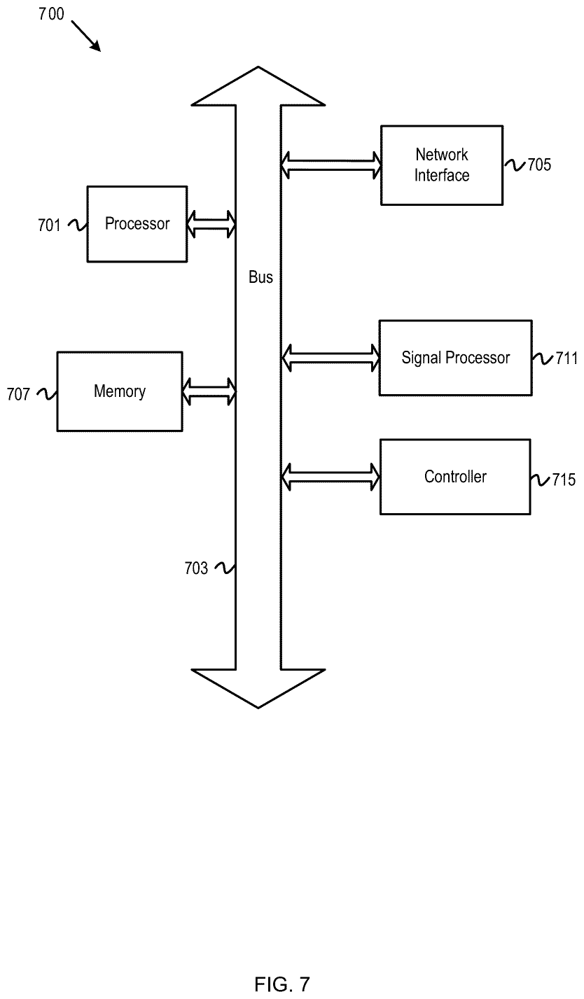

FIG. 1 includes a computer 170. The computer 170 may be local or remote to the geographic area 100. A processor of the computer 170 may perform operations for determining emissions of hydrocarbon related attributes and/or hydrocarbon sites in a region of interest as described below. In some implementations, the processor of the computer 170 may control hydrocarbon site operations within regions 150 and 151 or subsequent operations of other hydrocarbon sites in other regions. For instance, the processor of the computer 170 may determine the emissions factor for the tank 116 on the hydrocarbon site 120 and determine the tank 116 is leaking due to an increase in emissions over a period of time. The processor of the computer may perform operations to divert fluid from flowing to the tank 116 to reduce emissions. An example of the computer 170 is depicted in FIG. 7, which is further described below.

### Example Operations

Examples operations are now described.

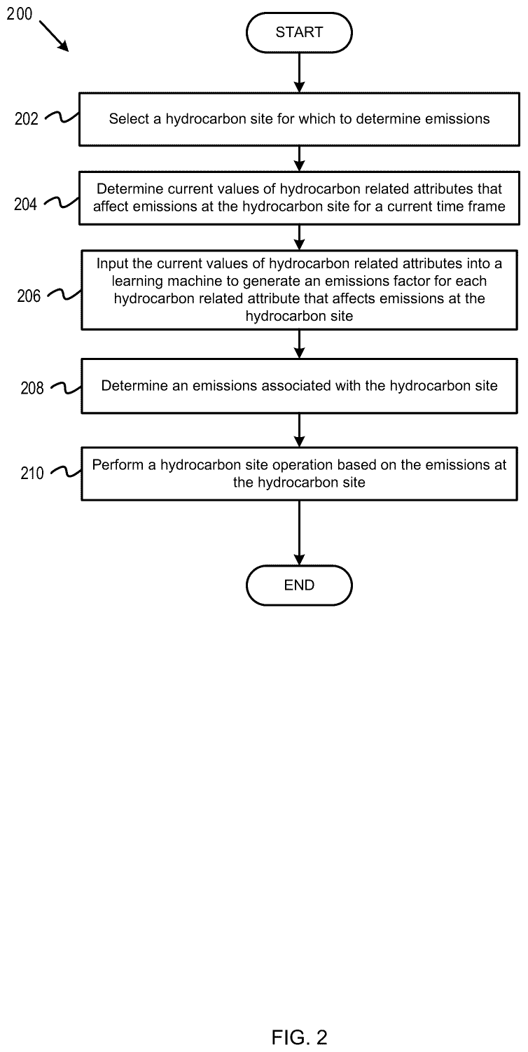

FIG. 2 is a flowchart depicting example operations for determining emissions for hydrocarbon recovery of a hydrocarbon site, according to some embodiments. FIG. 2 includes a flowchart 200 for generating emissions factors of hydrocarbon related attributes with a learning machine. Operations of flowchart 200 of FIG. 2 are described in reference to the processor of computer 170 of FIG. 1. Operations of the flowchart 200 start at block 202.

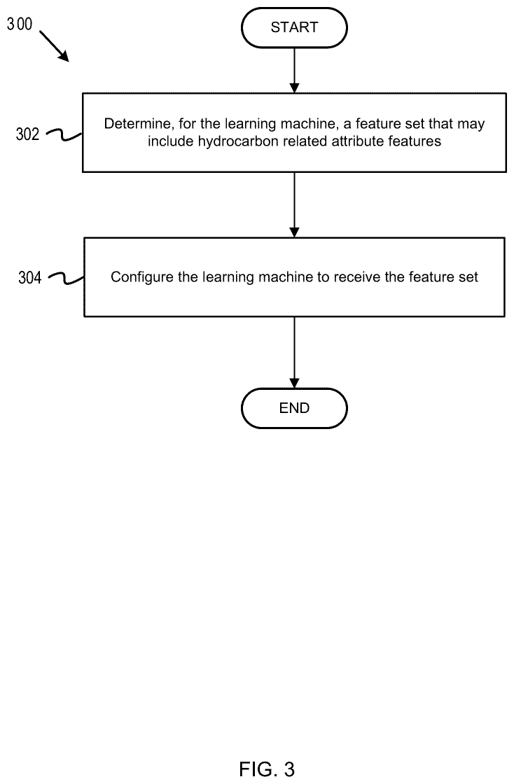

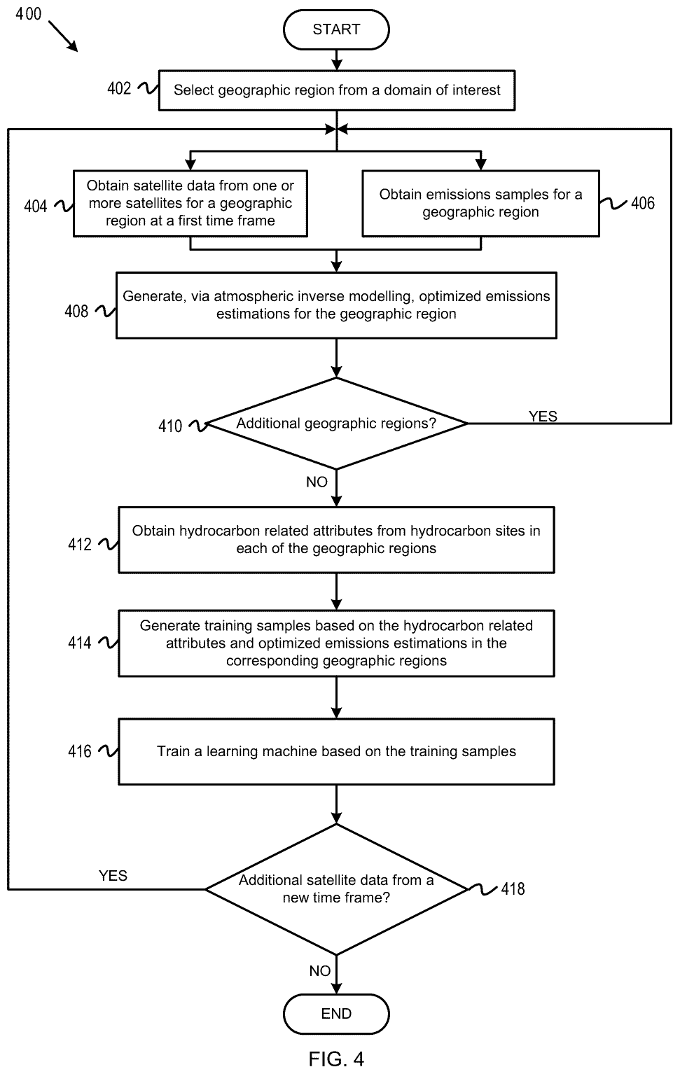

At block 202, the processor of the computer 170 may select a hydrocarbon site for which to determine emissions. A hydrocarbon site may include a site where hydrocarbon recovery operations such as drilling, completion, production, transportation, etc., or a combination thereof, may be performed. For example, the hydrocarbon site may be similar to hydrocarbon sites, 110, 120, and 140 of FIG. 1. In some embodiments. the hydrocarbon site may be located within a region in which a learning machine was trained with. Configuration and training of the learning machine is described in FIGS. 3 and 4 below, respectively.

At block 204, the processor of the computer 170 may determine current values of hydrocarbon related attributes that affect emissions at the hydrocarbon site for a current time frame. The current values of hydrocarbon related attributes may include inventory data, operational data, metadata, and site data as described in FIG. 1. The hydrocarbon related attributes may be manually determined and/or automatically determined. For example, the hydrocarbon related attributes may be obtained from a database comprising hydrocarbon related attributes for corresponding hydrocarbon sites.

At block 206, the processor of the computer 170 may input the current values of hydrocarbon related attributes into a learning machine to generate an emissions factor for each hydrocarbon related attribute that affects emissions at the hydrocarbon site. The learning machine may be configured to accept the hydrocarbon related attributes as inputs, as described in FIG. 3. Additionally, the learning machine may be trained to generate emissions factors for each of the hydrocarbon related attributes, as described in FIG. 4. In some embodiments, the emissions factors may be based on a specific time frame. For example, the learning machine may be trained to generate emissions factors for the current time frame. The learning machine may generate new emissions factors for the same hydrocarbon related attributes if the learning machine is trained on satellite data at a future time frame.

At block 208, the processor of the computer 170 may determine an emissions associated with the hydrocarbon site. The emissions of the site may include the quantity of greenhouse gases emitted over a period of time. For example, the emissions rate of a hydrocarbon site may have a methane emissions of 10,000 standard cubic feet per day (10 mscf/d). In some embodiments, the emissions of a hydrocarbon site may be the sum of emissions from the hydrocarbon related attributes associated with that site. For example, the emissions factor (determined in block 206) of an attribute may be multiplied by the activity rate (i.e., production rates) to generate the emissions for said attribute. The emissions from each attribute associated with a hydrocarbon site may then be summed to generate the emissions of the hydrocarbon site. In some embodiments, the emissions of a hydrocarbon site may not include emissions from all hydrocarbon related attributes. For example, emissions from one or more hydrocarbon related attributes may be omitted when generating the total emissions for the hydrocarbon site. In some embodiments, the emissions of the hydrocarbon site may be updated based on the updated emissions factors generated for a new time frame, as described in block 206. For example, the emissions for each of the hydrocarbon related attributes for a new time frame may be updated with the updated emissions factor generated in block 206, and the hydrocarbon site emissions may subsequently be updated.

At block 210, the processor of the computer 170 may perform a hydrocarbon site operation based on the emissions at the hydrocarbon site.

FIG. 3 is a flowchart depicting example operations to configure a learning machine, according to some embodiments. FIG. 3 includes a flowchart 300 that may determine a feature set and may configure the learning machine to receive the feature set as input. Operations of flowchart 300 of FIG. 3 are described in reference to the processor of computer 170 of FIG. 1. Operations of the flowchart 300 start at block 302.

At block 302, the processor of the computer 170 may determine, for the learning machine, a feature set that may include hydrocarbon related attribute features. A hydrocarbon related attribute feature may include features including inventory data features, operation data features, metadata features, and site data features. The feature set may also include optimized emission estimation features, a geological region identifier, etc. Some implementations may utilize any suitable feature set including any suitable value related to the sediment packages.

At block 304 the processor of the computer 170 may configure the learning machine to receive the feature set as input. In some embodiments, the learning machine may include a machine-learning based model, such as a data science machine learning model. As noted, the features may include hydrocarbon related attribute features. The flowchart 300 ends after block 304.

After block 304, the learning machine may begin training itself based on training samples. The discussion of FIG. 4 provides additional details about training samples and training the learning machine.

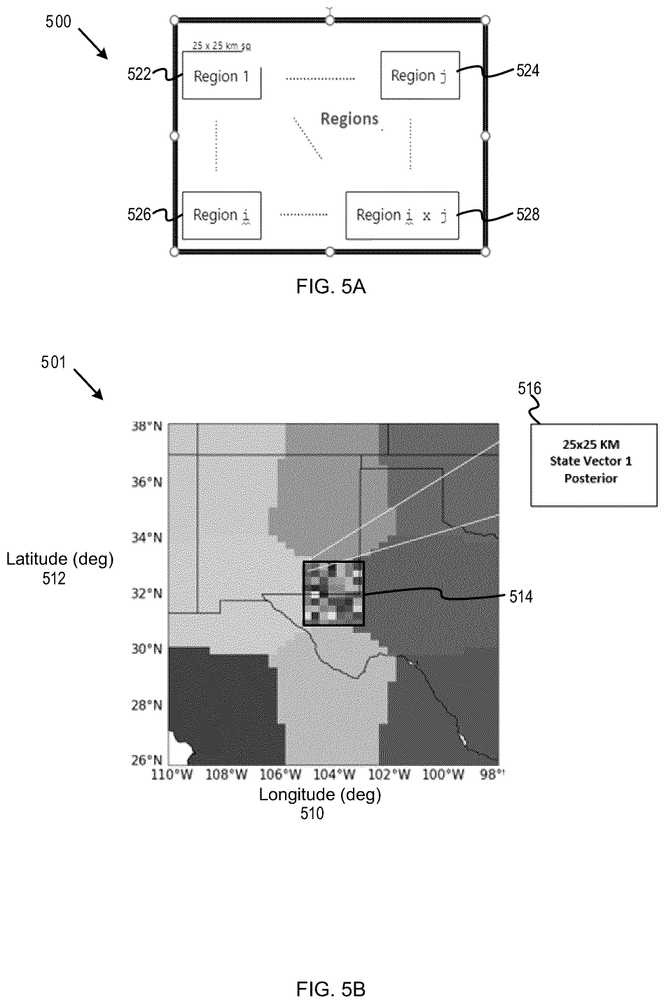

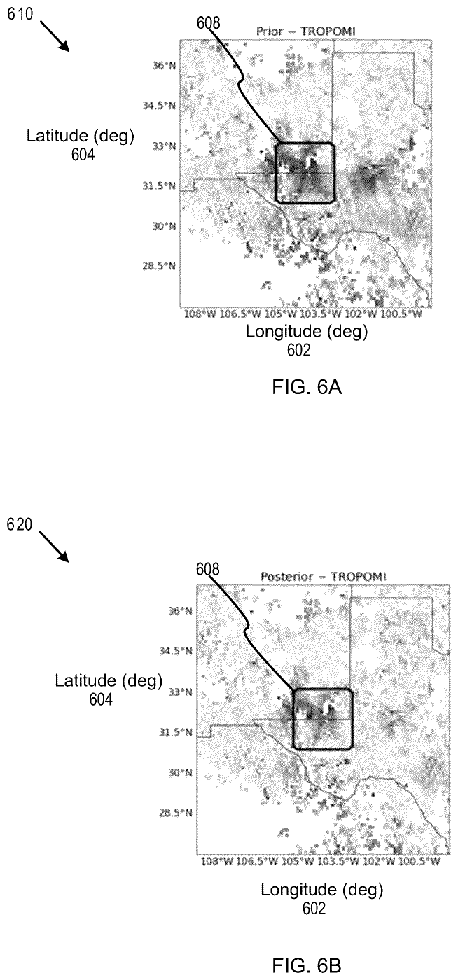

FIG. 4 is a flowchart depicting example operations to train a learning machine, according to some embodiments. FIG. 4 includes a flowchart 400 that may generate training samples and may train a learning machine with the training samples. Operations of flowchart 400 of FIG. 4 are described in reference to the processor of computer 170 of FIG. 1. Additionally, the operations of flowchart 400 of FIG. 4 are described in reference to FIGS. 5A-5B and FIGS. 6A-6B. Operations of the flowchart 400 start at block 402.

At block 402, the processor of the computer 170 may select a geographic region from a domain of interest. A domain of interest may be a geographic area in a basin, such as the geographic area 100 of FIG. 1. The domain of interest may include one or more geographic regions, such as the geographic regions 150 and 151 of FIG. 1. The size of each geographic region, and thus the number of geographic regions, may depend on the resolution of the satellite data available, as described in block 404. To help illustrate, FIGS. 5A-5B are illustrations depicting example domains of interest, according to some embodiments. FIG. 5A includes a geographic area 500. The geographic area 500 may be divided into geographic regions 522, 524, 526, 528. The size of the geographic regions 522, 524, 526, 528 may depend on the satellite resolutions. For example, satellite data obtained from a TROPOMI satellite may have a resolution of 25 km by 25 km, thus the dimensions of the geographic regions 522, 524, 526, 528 may be 25 km by 25 km. In some embodiments, the size of the geographic regions, such as geographic region 516, may change based on the satellite data obtained from one or more satellites at the current time frame. The geographic regions may be represented as a state vector of size i×j, where i and j may represent the size of the domain of interest (e.g., geographic area 100 of FIG. 1). In some embodiments, the geographic area may be defined by latitude and longitude coordinates. For example, FIG. 5B includes a basin 501. The basin includes a geological area 514 made up of geographic regions, such as geographic region 516. In this example illustration, the geographic region 516 is 25 km by 25 km. The basin 501 includes an x-axis 510 and a y-axis 512. The x-axis 510 is the longitude measured in degrees (deg). The y-axis 512 is the latitude measured in degrees (deg).

At block 404, the processor of the computer 170 may obtain satellite data from one or more satellites for a geographic region at a current time frame. The satellite data may include one or more columnar concentrations of greenhouse gases over an area of interest. For example, the concentrations of greenhouse gases may include methane columnar concentrations. The satellite data may include emissions data from one or more satellites such as a TROPOMI satellite, a MethaneSAT satellite, a GHGSat satellite, etc. The data from the one or more satellites may be available at different frequencies. For example, data from a TROPOMI satellite may be available daily and data from satellites such as MethaneSAT, GHGSat, etc. may be intermittently available. The satellite data obtained at the current time frame may include the most current satellite data available at that current time. The resolution of the satellite data may differ between satellites. For example, data from a TROPOMI satellite may have a resolution of 7 kilometers by 5.5 kilometers and data from a MethaneSAT satellite may have a resolution of 130 meters by 400 meters. In some embodiments, the satellite data may be emissions from all sources of emissions. For example, the emissions captured in the satellite data may be emissions from oil and gas operations, agriculture, transportation, etc.

To help illustrate, FIGS. 6A-6B are illustrations depicting example satellite data, according to some embodiments. FIG. 6A includes raw satellite data 610. The raw satellite data 610 includes an x-axis 602 and a y-axis 604. The x-axis 602 is the longitude in degrees (deg). The y-axis 604 is the latitude in degrees (deg). The satellite data in the raw satellite data 610 comprises emissions from approximately all emissions sources (hydrocarbon operations, agriculture, transportation, etc.). The geographic area 608 may be similar to the geographic area 500 of FIG. 5 comprising a plurality of geographic regions. Each of the geographic regions within the geographic area 608 may have corresponding satellite data representing the emissions from each geographic region. FIG. 6B includes optimized emissions estimations 620. The satellite data of the optimized emissions estimations has been reduced, via atmospheric inverse modeling, to emissions relating to hydrocarbon operations. The generation of optimized emissions estimations is described in blocks 406-408.

At block 406, the processor of the computer 170 may obtain emissions samples for the geographic region. The emissions samples may include priors or custom bottom-up inventory. The emissions samples may be obtained from open sources such as the environmental protection agency (EPA), an oil production greenhouse gas emission estimator (OPGEE), etc. For example, the emissions samples may include emissions factors published by the EPA. The bottom up inventory and/or priors may be utilized as prior knowledge for atmospheric inverse modeling. The prior knowledge may indicate the emissions factors related to hydrocarbon operations in the geographic region. For example, the prior knowledge may be the emissions factors for the geographic region in the geographic area 608 of FIG. 6A-6B. Block 406 may be performed before, after, or parallel to block 404.

At block 408, the processor of the computer 170 may generate, via atmospheric inverse modeling, optimized emissions estimations for the geographic region. The satellite data and the emissions samples may be input into an atmospheric inverse model to generate the optimized emissions estimations for the geographic region.

The atmospheric inverse model may include methods such as Bayesian inversion. The optimized emissions estimations may represent the estimated emissions from hydrocarbon operations located in the geographic region. For example, the optimized emissions estimations 620 of FIG. 6B represents the satellite data of emissions in each geographic region filtered to emissions associate with hydrocarbon operations.

At block 410, the processor of the computer 170 may determine if there are additional geographic regions. If there are additional geographic regions in the geological area, then operations return to block 404, 406 for the next geographic region. Otherwise, operations proceed to block 412.

At block 412, the processor of the computer 170 may obtain hydrocarbon related attributes from hydrocarbon sites in each of the geographic regions. As described above, the hydrocarbon related attributes that affect emissions may include inventory data, operational data, metadata, and site data for each hydrocarbon site in each geographic region of a domain of interest. The hydrocarbon related attributes may be obtained from various sources, such as a database library.

At block 414, the processor of the computer 170 may generate training samples based on the hydrocarbon related attributes and optimized emissions estimations in the corresponding geographic regions. The hydrocarbon related attributes may represent the input variables in the training samples and the optimized emissions estimations may represent the target variables in the training samples. Each training sample may include the hydrocarbon related attributes for a geographic region and the optimized emissions estimations for said geographic region. In some embodiments, the hydrocarbon related attributes may be the attributes from a time frame similar to the time frame from which the optimized emissions estimations were generated. For example, the hydrocarbon related attributes may be present in a geographic region at a time frame similar to the time frame when the satellite data was obtained and subsequently the optimized emissions estimation was generated.

In some embodiments, the hydrocarbon related attributes may be aggregated. For example, the operational data may be aggregated for different equipment and may be converted to a single value for the geographic region. In some embodiments, said aggregation and conversion may be performed by a plurality of data dimensionality reduction techniques such as Principal Component Analysis (PCA), Factor Analysis (FA), etc. In some embodiments, if operational data is not available for all equipment on a hydrocarbon site, data imputation methods may be utilized as approximation for the training samples.

At block 416, the processor of the computer 170 may train a learning machine based on the training samples. The learning machine may use fewer than all the training samples in its training process. For example, the learning machine may utilize 80% of the training samples at block 410. Later, the learning machine may use the remaining 20% of the training samples to test the learning machine. The learning machine may be updated (i.e., trained) as new training samples are obtained. For instance, the learning machine be trained with updated training samples that are updated with higher resolution satellite data from a similar time frame. Alternatively, the learning machine may be trained with updated training samples that are updated with satellite data from a more current time frame. Updating the learning machine with updated satellite data is described in block 418. In some embodiments, the learning machine may be trained to output the emissions factors for hydrocarbon related attributes.

At block 418, the processor of the computer 170 may determine if there is additional satellite data from a new time frame. For example, new satellite data from one or more satellites may be obtained from a more current time frame that the original satellite data from which the learning machine was trained with. For example, satellite data from one or more satellites may be obtained every day, month, six months, etc. The training samples may be updated with the new satellite data if/when it may be obtained. If there is additional satellite data from a new time frame, then operations return to blocks 404, 406 to generate new training sample based on the new satellite data at the new time frame, and update (i.e., train) the learning machine based on the updated training samples. Otherwise, operations of the flowchart 400 are complete.

### Example Computer

FIG. 7 is a block diagram depicting an example computer, according to some embodiments. FIG. 7 depicts a computer 700 for quantifying emissions of a hydrocarbon site. The computer 700 includes a processor 701 (possibly including multiple processors, multiple cores, multiple nodes, and/or implementing multi-threading, etc.). The computer 700 includes memory 707. The memory 707 may be system memory or any one or more of the above already described possible realizations of machine-readable media. The computer 700 also includes a bus 703 and a network interface 705. The computer 700 can communicate via transmissions to and/or from remote devices via the network interface 705 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

The computer 700 also includes a signal processor 711 and a controller 1315 which may perform the operations described herein. For example, the signal processor 711 may generate posterior emissions estimations based on satellite data and emissions samples to train a learning machine, and generate, via the learning machine, emissions factors for hydrocarbon related attributes. The controller 715 may perform a hydrocarbon site operation based on the emissions factors. The signal processor 711 and the controller 715 can be in communication. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

While the aspects of the disclosure are described with reference to various implementations and exploitations, it will be understood that these aspects are illustrative and that the scope of the claims is not limited to them. In general, techniques for seismic horizon mapping as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Example Embodiments

Embodiment #1: A method for determining an emissions associated with hydrocarbon recovery of a hydrocarbon site within a geographic region, the method comprising: selecting the hydrocarbon site for which to determine the emissions; determining current values of hydrocarbon related attributes that affect emissions at the hydrocarbon site for a current time frame; and inputting the current values of the hydrocarbon related attributes related to emissions at the hydrocarbon site into a learning machine to generate an emissions factor for each of the hydrocarbon related attributes that affect the emissions at the hydrocarbon site.

Embodiment #2: The method of Embodiment #1, wherein the learning machine has been trained on data samples over a past number of time frames, wherein each data sample comprises, identification of the geographic region, emissions samples, the emissions samples including a level of emissions caused by hydrocarbon recovery in the geographic region for the past time frame, and previous values of the hydrocarbon related attributes that affect emissions in the geographic region for the past time frame.

Embodiment #3: The method of Embodiment #2, further comprising: obtaining a first satellite dataset for a geographic region at a first time frame, wherein the first satellite dataset includes columnar concentrations of one or more greenhouse gas; obtaining the emissions samples for the first time frame for the geographic region, wherein the emissions samples include emissions factors samples from an open-source dataset; and generating, via atmospheric inverse modelling, a posterior emissions estimation for the geographic region at the first time frame based on the first satellite dataset and the emissions samples.

Embodiment #4: The method of Embodiment #3, further comprising: identifying one or more hydrocarbon sites within the geographic region, the one or more hydrocarbon sites comprising hydrocarbon related attribute samples; generating training samples, wherein the training samples include the hydrocarbon related attribute samples within the geographic region and the posterior emissions estimation corresponding to the geographic region; and training, with the training samples, the learning machine to generate emissions factors for hydrocarbon site attributes.

Embodiment #5: The method of Embodiments #3 or 4, further comprising: obtaining a second satellite dataset from a second time frame; generating an updated posterior emissions estimation for the geographic region; updating the learning machine based on the updated posterior emissions estimation and the emissions samples for the second time frame; and inputting the hydrocarbon related attributes into the learning machine to generate an updated emissions factor for each of the hydrocarbon related attributes.

Embodiment #6: The method of any one or more of Embodiments #3-5,

wherein the first satellite dataset includes satellite data from one or more satellites, the satellite data from each of the one or more satellites having different resolutions.

Embodiment #7: The method of any one or more of Embodiments #1-6, further comprising: determining the emissions associated with hydrocarbon recovery of the hydrocarbon site based on the emissions factor for each of the hydrocarbon related attributes that affect the emissions at the hydrocarbon site.

Embodiment #8: The method of any one or more of Embodiments #1-7, wherein the hydrocarbon related attributes include inventory data, operational data, and metadata of a hydrocarbon site.

Embodiment #9: The method of any one or more of Embodiments #1-8, further comprising: performing a hydrocarbon site operation based on the emissions factor for each of the hydrocarbon related attributes.

Embodiment #10: A non-transitory computer-readable medium including computer-executable instructions comprising: instructions to select a hydrocarbon site for which to determine emissions associated with hydrocarbon recovery of the hydrocarbon site within a geographic region; instructions to determine current values of hydrocarbon related attributes that affect emissions at the hydrocarbon site for a current time frame; and instructions to input the current values of the hydrocarbon related attributes related to emissions at the hydrocarbon site into a learning machine to generate an emissions factor for each of the hydrocarbon related attributes that affect the emissions at the hydrocarbon site

Embodiment #11: The non-transitory computer-readable medium of Embodiment #10, wherein the learning machine has been trained on data samples over a past number of time frames, wherein each data sample comprises, identification of the geographic region, emissions samples, the emissions samples including a level of emissions caused by hydrocarbon recovery in the geographic region for the past time frame, and previous values of the hydrocarbon related attributes that affect emissions in the geographic region for the past time frame.

Embodiment #12: The non-transitory computer-readable medium of Embodiment #11, further comprising: instructions to obtain a first satellite dataset for a geographic region at a first time frame, wherein the first satellite dataset includes columnar concentrations of one or more greenhouse gas; instructions to obtain the emissions samples for the first time frame for the geographic region, wherein the emissions samples include emissions factors samples from an open-source dataset; and instructions to generate, via atmospheric inverse modelling, a posterior emissions estimation for the geographic region at the first time frame based on the first satellite dataset and the emissions samples.

Embodiment #13: The non-transitory computer-readable medium of Embodiment #12, further comprising: instructions to identify one or more hydrocarbon sites within the geographic region, the one or more hydrocarbon sites comprising hydrocarbon related attribute samples; instructions to generate training samples, wherein the training samples include the hydrocarbon related attribute samples within the geographic region and the posterior emissions estimation corresponding to the geographic region; and instructions to train, with the training samples, the learning machine to generate emissions factors for hydrocarbon site attributes.

Embodiment #14: The non-transitory computer-readable medium of any one or more of Embodiments #10-13, further comprising: instructions to determine the emissions associated with hydrocarbon recovery of the hydrocarbon site based on the emissions factor for each of the hydrocarbon related attributes that affect the emissions at the hydrocarbon site.

Embodiment #15: The non-transitory computer-readable medium of any one

or more of Embodiments #10-14, wherein the hydrocarbon related attributes include inventory data, operational data, and metadata of a hydrocarbon site.

Embodiment #16: A system comprising: a processor; and a computer-readable medium having instructions stored thereon that are: instructions to select a hydrocarbon site for which to determine emissions associated with hydrocarbon recovery of the hydrocarbon site within a geographic region; instructions to determine current values of hydrocarbon related attributes that affect emissions at the hydrocarbon site for a current time frame; and instructions to input the current values of the hydrocarbon related attributes related to emissions at the hydrocarbon site into a learning machine to generate an emissions factor for each of the hydrocarbon related attributes that affect the emissions at the hydrocarbon site.

Embodiment #17: The system of Embodiment #16, wherein the learning machine has been trained on data samples over a past number of time frames, wherein each data sample comprises, identification of the geographic region, emissions samples, the emissions samples including a level of emissions caused by hydrocarbon recovery in the geographic region for the past time frame, and previous values of the hydrocarbon related attributes that affect emissions in the geographic region for the past time frame.

Embodiment #18: The system of Embodiment #17, further comprising: instructions to obtain a first satellite dataset for a geographic region at a first time frame, wherein the first satellite dataset includes columnar concentrations of one or more greenhouse gas; instructions to obtain the emissions samples for the first time frame for the geographic region, wherein the emissions samples include emissions factors samples from an open-source dataset; and instructions to generate, via atmospheric inverse modelling, a posterior emissions estimation for the geographic region at the first time frame based on the first satellite dataset and the emissions samples.

Embodiment #19: The system of Embodiment #18, further comprising: instructions to identify one or more hydrocarbon sites within the geographic region, the one or more hydrocarbon sites comprising hydrocarbon related attribute samples; instructions to generate training samples, wherein the training samples include the hydrocarbon related attribute samples within the geographic region and the posterior emissions estimation corresponding to the geographic region; and instructions to train, with the training samples, the learning machine to generate emissions factors for hydrocarbon site attributes.

Embodiment #20: The system of any one or more of Embodiments #16-19, further comprising: instructions to determine the emissions associated with hydrocarbon recovery of the hydrocarbon site based on the emissions factor for each of the hydrocarbon related attributes that affect the emissions at the hydrocarbon site.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A method for determining an emissions associated with hydrocarbon recovery of a hydrocarbon site within a geographic region, the method comprising:
selecting the hydrocarbon site for which to determine the emissions;
determining current values of hydrocarbon related attributes that affect emissions at the hydrocarbon site for a current time frame; and
inputting the current values of the hydrocarbon related attributes related to emissions at the hydrocarbon site into a learning machine to generate an emissions factor for each of the hydrocarbon related attributes that affect the emissions at the hydrocarbon site.

2. The method of claim 1, wherein the learning machine has been trained on data samples over a past number of time frames, wherein each data sample comprises,
identification of the geographic region,
emissions samples, the emissions samples including a level of emissions caused by hydrocarbon recovery in the geographic region for the past time frame, and
previous values of the hydrocarbon related attributes that affect emissions in the geographic region for the past time frame.

3. The method of claim 2, further comprising:
obtaining a first satellite dataset for a geographic region at a first time frame, wherein the first satellite dataset includes columnar concentrations of one or more greenhouse gas;
obtaining the emissions samples for the first time frame for the geographic region, wherein the emissions samples include emissions factors samples from an open-source dataset; and
generating, via atmospheric inverse modelling, a posterior emissions estimation for the geographic region at the first time frame based on the first satellite dataset and the emissions samples.

4. The method of claim 3, further comprising:
identifying one or more hydrocarbon sites within the geographic region, the one or more hydrocarbon sites comprising hydrocarbon related attribute samples;
generating training samples, wherein the training samples include the hydrocarbon related attribute samples within the geographic region and the posterior emissions estimation corresponding to the geographic region; and
training, with the training samples, the learning machine to generate emissions factors for hydrocarbon site attributes.

5. The method of claim 3, further comprising:
obtaining a second satellite dataset from a second time frame;
generating an updated posterior emissions estimation for the geographic region;
updating the learning machine based on the updated posterior emissions estimation and the emissions samples for the second time frame; and
inputting the hydrocarbon related attributes into the learning machine to generate an updated emissions factor for each of the hydrocarbon related attributes.

6. The method of claim 3, wherein the first satellite dataset includes satellite data from one or more satellites, the satellite data from each of the one or more satellites having different resolutions.

7. The method of claim 1, further comprising:
determining the emissions associated with hydrocarbon recovery of the hydrocarbon site based on the emissions factor for each of the hydrocarbon related attributes that affect the emissions at the hydrocarbon site.

8. The method of claim 1, wherein the hydrocarbon related attributes include inventory data, operational data, and metadata of a hydrocarbon site.

9. The method of claim 1, further comprising:
performing a hydrocarbon site operation based on the emissions factor for each of the hydrocarbon related attributes.

10. A non-transitory computer-readable medium including computer-executable instructions comprising:
instructions to select a hydrocarbon site for which to determine emissions associated with hydrocarbon recovery of the hydrocarbon site within a geographic region;
instructions to determine current values of hydrocarbon related attributes that affect emissions at the hydrocarbon site for a current time frame; and
instructions to input the current values of the hydrocarbon related attributes related to emissions at the hydrocarbon site into a learning machine to generate an emissions factor for each of the hydrocarbon related attributes that affect the emissions at the hydrocarbon site.

11. The non-transitory computer-readable medium of claim 10, wherein the learning machine has been trained on data samples over a past number of time frames, wherein each data sample comprises,
identification of the geographic region,
emissions samples, the emissions samples including a level of emissions caused by hydrocarbon recovery in the geographic region for the past time frame, and
previous values of the hydrocarbon related attributes that affect emissions in the geographic region for the past time frame.

12. The non-transitory computer-readable medium of claim 11, further comprising:
instructions to obtain a first satellite dataset for a geographic region at a first time frame, wherein the first satellite dataset includes columnar concentrations of one or more greenhouse gas;
instructions to obtain the emissions samples for the first time frame for the geographic region, wherein the emissions samples include emissions factors samples from an open-source dataset; and
instructions to generate, via atmospheric inverse modelling, a posterior emissions estimation for the geographic region at the first time frame based on the first satellite dataset and the emissions samples.

13. The non-transitory computer-readable medium of claim 12, further comprising:
instructions to identify one or more hydrocarbon sites within the geographic region, the one or more hydrocarbon sites comprising hydrocarbon related attribute samples;
instructions to generate training samples, wherein the training samples include the hydrocarbon related attribute samples within the geographic region and the posterior emissions estimation corresponding to the geographic region; and
instructions to train, with the training samples, the learning machine to generate emissions factors for hydrocarbon site attributes.

14. The non-transitory computer-readable medium of claim 10, further comprising:
instructions to determine the emissions associated with hydrocarbon recovery of the hydrocarbon site based on the emissions factor for each of the hydrocarbon related attributes that affect the emissions at the hydrocarbon site.

15. The non-transitory computer-readable medium of claim 10, wherein the hydrocarbon related attributes include inventory data, operational data, and metadata of a hydrocarbon site.

16. A system comprising:
a processor; and
a computer-readable medium having instructions stored thereon that are:
instructions to select a hydrocarbon site for which to determine emissions associated with hydrocarbon recovery of the hydrocarbon site within a geographic region;
instructions to determine current values of hydrocarbon related attributes that affect emissions at the hydrocarbon site for a current time frame; and
instructions to input the current values of the hydrocarbon related attributes related to emissions at the hydrocarbon site into a learning machine to generate an emissions factor for each of the hydrocarbon related attributes that affect the emissions at the hydrocarbon site.

17. The system of claim 16, wherein the learning machine has been trained on data samples over a past number of time frames, wherein each data sample comprises,
identification of the geographic region,
emissions samples, the emissions samples including a level of emissions caused by hydrocarbon recovery in the geographic region for the past time frame, and
previous values of the hydrocarbon related attributes that affect emissions in the geographic region for the past time frame.

18. The system of claim 17, further comprising:
instructions to obtain a first satellite dataset for a geographic region at a first time frame, wherein the first satellite dataset includes columnar concentrations of one or more greenhouse gas;
instructions to obtain the emissions samples for the first time frame for the geographic region, wherein the emissions samples include emissions factors samples from an open-source dataset; and
instructions to generate, via atmospheric inverse modelling, a posterior emissions estimation for the geographic region at the first time frame based on the first satellite dataset and the emissions samples.

19. The system of claim 18, further comprising:
instructions to identify one or more hydrocarbon sites within the geographic region, the one or more hydrocarbon sites comprising hydrocarbon related attribute samples;
instructions to generate training samples, wherein the training samples include the hydrocarbon related attribute samples within the geographic region and the posterior emissions estimation corresponding to the geographic region; and
instructions to train, with the training samples, the learning machine to generate emissions factors for hydrocarbon site attributes.

20. The system of claim 16, further comprising:
instructions to determine the emissions associated with hydrocarbon recovery of the hydrocarbon site based on the emissions factor for each of the hydrocarbon related attributes that affect the emissions at the hydrocarbon site.
